(19) United States
(12) Patent Application Publication
(10) Pub. No.: US 2009/0096925 A1
(43) Pub. Date: Apr. 16, 2009

(54) Method for providing additional information of digital broadcasting application

(75) Inventors: Wonjang Baek, Gyeonggi-do (KR); John Kim, Seoul (KR); Seong Baek Lee, Seoul (KR)

Correspondence Address: THE NATH LAW GROUP, 112 South West Street, Alexandria, VA, 22314, US

(73) Assignee: DREAMER Inc., Seoul (KR)

(21) Appl. No.: 12/285,534

(22) Filed: Oct. 8, 2008

(30) Foreign Application Priority Data
Oct. 10, 2007 (DE) 10 2007-0102107

(51) Int. Cl. H04N 5/445

(52) U.S. Cl. 348/563; 348/E05.099

(57) ABSTRACT

A method for providing an additional information of a digital broadcasting application is disclosed. In accordance with the method of the present invention, a base information of a broadcast program and the additional information dynamically extracted based on the base information for a personalization may be provided to a specific viewer or a specific viewer group.

This application claims the benefit of Korean Patent Application No. 10-2007-0102107 filed on Oct. 10, 2007, which are hereby incorporated for reference.

### BACKGROUND OF THE INVENTION

1. Field of the Invention

The present invention relates to a method for providing an additional information of a digital broadcasting application, and more particularly to a method for providing an additional information of a digital broadcasting application wherein a base information of a broadcast program and an additional information dynamically extracted based on the base information for a personalization may be provided to a specific viewer or viewer group.

2. Description of the Related Art

A broadcasting environment is changing according to a development of technologies and a demand of viewers. As a broadcasting media becomes diverse, the broadcasting environment makes transition from a conventional analog broadcasting to a digital broadcasting, and from a terrestrial broadcasting to a cable broadcasting, a satellite broadcasting, an IP-TV (Internet Protocol TV) which is a service for providing a multimedia data using a high speed communication network, a T-DMB (Terrestrial Digital Multimedia Broadcasting) and a S-DMB (Satellite Digital Multimedia Broadcasting).

A capacity of the digital broadcasting is four to eight times that of the conventional analog broadcasting such that additional services in various fields such as sports, movies, home shoppings and musics may be provided. Moreover, thanks to the diverse broadcasting media, the viewer may choose from a large selection of the broadcasting media such as the cable broadcasting, the satellite broadcasting, the IP-TV and the DMBs as well as terrestrial broadcasting.

In addition, various digital broadcasting applications as well as a conventional broadcast program may be transmitted in the digital broadcasting. The digital broadcasting is capable of associating with a data included in the broadcast program or a data additionally transmitted though a return channel, thereby allowing the digital broadcasting application with interactive capabilities.

Various data services using the digital broadcasting application are expected to play an important role in spreading the digital broadcasting due to an easy use for the viewer.

However, in accordance with a conventional method for providing the digital broadcasting application, the number of or a size of the digital broadcasting application is limited due to a limited resource for executing the digital broadcasting application and a limited bandwidth for transmitting the digital broadcasting application. That is, when the size of the digital broadcasting application is excessively large, the receiver cannot execute the digital broadcasting application, and a time required for transmitting the digital broadcasting application increases, thereby lacking in practicality.

That is, although the viewer may be provided with a base information, it is difficult to provide an additional information corresponding to the base information. For instance, although the base information such as an introduction information on the broadcast program may be provided to the viewer, it is difficult to provide the additional information such as a T-commerce information or an advertisement information.

Particularly, it is difficult to provide a personalized digital broadcasting application, e.g., the additional information suitable for a specific viewer or viewer group.

### SUMMARY OF THE INVENTION

It is an object of the present invention to provide a method for providing an additional information of a digital broadcasting application wherein a base information of a broadcast program and an additional information dynamically extracted based on the base information for a personalization may be provided to specific viewer and viewer group.

In accordance with a first aspect of the present invention, there is provided a method for providing an additional information of a digital broadcasting in an application providing server providing a digital broadcasting application, the method comprising steps of: (a) obtaining a base information of a broadcast program; (b) selecting the additional information complying with the base information by analyzing the base information; (c) generating the digital broadcasting application by formatting the base information and the additional information; and (d) transmitting the digital broadcasting application generated to correspond to the broadcast program to a receiver for receiving the broadcast program.

Preferably, the base information includes at least one of a description information and an additional display information of the broadcast program.

The method in accordance with the present invention may further comprising (e) transmitting a trigger application to the receiver prior to carrying out the step (a), and wherein the step (a) comprises: (a-1) receiving an identification information on the broadcast program currently received by the receiver through the trigger application; and (a-2) identifying the broadcast program through the identification information.

Preferably, the step (b) comprises: (b-1) storing a plurality of the additional information according to a classification criteria; (b-2) analyzing the base information to select a keyword; (b-3) extracting the additional information corresponding to the keyword from the plurality of the additional information.

Preferably, the step (b) comprises: (b-1) transmitting the base information to an additional information providing server storing a plurality of the additional information according to a classification criteria; and (b-2) extracting the additional information corresponding to the base information from the additional information providing server.

Preferably, the step (c) comprises generating the digital broadcasting application including an independent execution code to be executed on a scene-by-scene basis and a resource data, and wherein the step (d) comprises transmitting the digital broadcasting application on the scene-by-scene basis.

Preferably, the method in accordance with claim 6, wherein the step (c) comprises: (c-1) allocating areas for the base information and the additional information for each scene; and (c-2) generating the digital broadcasting application by disposing the base information and the additional information in the areas for the base information and the additional information, respectively.

Preferably, the area for the base information may overlap with the area for the additional information.

Preferably, the step (c) comprises: (c-1) generating a plurality of scenes corresponding to the additional information based on a user profile; and (c-2) generating the digital broadcasting application by providing an identification information corresponding to the user profile to each of the plurality of scenes, and wherein the step (d) comprises transmitting the plurality of scenes to the receiver.

Preferably, the step (d) comprises: (d-1) receiving an application transmission request for a transmission of the digital broadcasting application generated to correspond to the broadcast program from the receiver; and (d-2) transmitting the digital broadcasting application to the receiver according to the application transmission request.

Preferably, the step (c) comprises: (c-1) generating a plurality of scenes corresponding to the additional information based on a user profile; and (c-2) generating the digital broadcasting application by assigning, to each of the plurality of scenes, a scene identification information corresponding to the user profile, and wherein the step (d) comprises: (d-1) receiving an application transmission request for a transmission of the digital broadcasting application generated to correspond to the broadcast program from the receiver; (d-2) obtaining an identification information of the receiver according to the application transmission request; (d-3) comparing the identification information of the receiver with the scene identification information to extract at least one of the plurality of scenes wherein the identification information of the receiver conforms to the scene identification information; and (d-4) transmitting the scene extracted in the step (d-3) to the receiver according to the application transmission request.

Preferably, the additional information includes a network identification information for a content accessible through a return channel by the receiver.

Preferably, the additional information includes an advertisement information.

In accordance with a second aspect of the present invention, there is a method for providing an additional information of a digital broadcasting application in an additional information providing server providing the additional information, the method comprising steps of: (a) obtaining a base information of the digital broadcasting application; (b) selecting the additional information complying with the base information by analyzing the base information; (c) generating an auxiliary digital broadcasting application based on the additional information; and (d) transmitting the auxiliary digital broadcasting application to one of an application providing server providing the digital broadcasting application and a receiver receiving the digital broadcasting application.

Preferably, the base information includes at least one of a description information and an additional display information of a broadcast program.

Preferably, the step (b) comprises: (b-1) storing a plurality of the additional information according to a classification criteria; (b-2) analyzing the base information to select a keyword; and (b-3) extracting the additional information corresponding to the keyword from the plurality of the additional information.

Preferably, the step (c) comprises generating the auxiliary digital broadcasting application including an independent execution code to be executed on a scene-by-scene basis and a resource data, and wherein the step (d) comprises transmitting the auxiliary digital broadcasting application on the scene-by-scene basis.

Preferably, the step (d) comprises: (d-1) receiving an application transmission request for a transmission of the auxiliary digital broadcasting application generated to correspond to a broadcast program; and (d-2) transmitting the auxiliary digital broadcasting application to the receiver according to the application transmission request.

Preferably, the step (c) comprises: (c-1) generating a plurality of scenes corresponding to the additional information based on a user profile; and (c-2) generating the auxiliary digital broadcasting application by assigning, to each of the plurality of scenes, a scene identification information corresponding to the user profile, and wherein the step (d) comprises: (d-1) receiving an application transmission request for a transmission of the auxiliary digital broadcasting application generated to correspond to the broadcast program from the receiver; (d-2) obtaining an identification information of the receiver corresponding the application transmission request; (d-3) comparing the identification information of the receiver with the scene identification information to extract at least one of the plurality of scenes wherein the identification information of the receiver conforms to the scene identification information; and (d-4) transmitting the scene extracted in the step (d-3) to the receiver according to the application transmission request.

Preferably, the auxiliary digital broadcasting application includes an attribution information displayed by the receiver.

### BRIEF DESCRIPTION OF THE DRAWINGS

FIG. 1 is a flow diagram illustrating a method for providing an additional information of a digital broadcasting application in accordance with an embodiment of the present invention.

FIG. 2 is a flow diagram illustrating a method for providing an additional information of a digital broadcasting application in accordance with another embodiment of the present invention.

### DETAILED DESCRIPTION OF THE INVENTION

A method for providing an additional information of a digital broadcasting application in accordance with the present invention will now be described in detail with reference to the accompanied drawings.

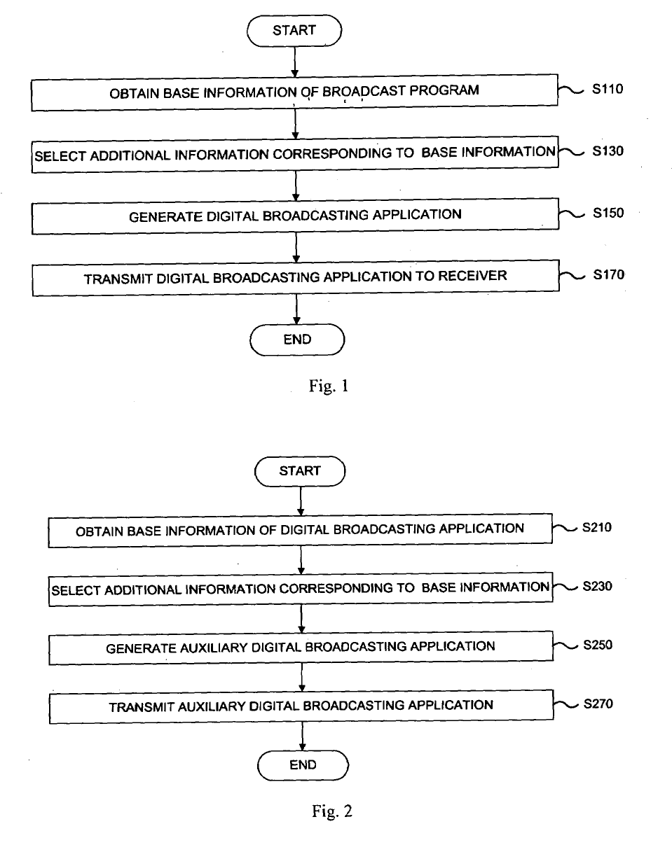

FIG. 1 is a flow diagram illustrating a method for providing an additional information of a digital broadcasting application in accordance with an embodiment of the present invention.

The flow diagram of FIG. 1 illustrates a method for providing an additional information of a digital broadcasting application in accordance with the present invention, which is embodied in an application providing server providing the digital broadcasting application. The application providing server may be associated with a head-end system of a broadcasting corporation.

Referring FIG. 1, a base information of a broadcast program is obtained (S110).

The base information may include a description information or an additional display information of the broadcast program. For instance, the base information may include an additional information on a leading character for a TV show and a plot of each episode thereof.

A method for extracting the base information of the broadcast program currently received by a receiver is described in more detail.

The application providing server transmits a trigger application to the receiver receiving the broadcast program.

The trigger application refers to a digital broadcasting application capable of obtaining an information on the broadcast program currently received by the receiver or capable of extracting an information on a viewer watching the broadcast program.

The application providing server may receive, from the receiver, an identification information on the broadcast program currently received by the receiver through the trigger application to identify the broadcast program. Therefore, the application providing server may obtain the description information or the additional display information of the broadcast program.

Thereafter, the additional information complying with or corresponding to the base information is selected by analyzing the base information obtained in the step S110 (S130).

A plurality of the additional information may be stored in the application providing server, and at least on may be selected from the plurality of the additional information stored therein.

The plurality of the additional information may be stored in the application providing server according to a classification criteria.

The additional information may include an advertisement information including informations on a purchase, a promotion and an advertisement of a product related to the broadcast program, and a network identification information representing a content for participating in the purchase and the promotion of the product.

Preferably, the receiver may access the content represented by the network identification information through a return channel.

Alternately, a plurality of the additional information may also be stored in an additional information providing server, and at least on may be selected from the plurality of the additional information stored therein.

The plurality of the additional information may be stored in the additional information providing server according to a classification criteria as well.

That is, when the application providing server transmits the base information obtained in the step S110 to the additional information providing server storing the plurality of the additional information, the additional information providing server extracts the additional information corresponding to the base information from the plurality of the additional information.

The additional information corresponding to the base information is extracted in order to provide the viewer with the additional information complying with the base information.

Thereafter, a keyword is selected by analyzing the base information obtained in the step S110.

The keyword may be selected based on a title of the TV show, a name of the leading character and a plot information. In addition, the keyword may be selected by analyzing an information which is statistically extractable based on the title, e.g. an information on a main class of the viewer.

Thereafter, the additional information corresponding to the keyword is extracted from the plurality of the additional information.

For instance, when the keyword such as “drama”, “women in their thirties”, “bag” and “clothes” is extracted, the additional information corresponding to the keyword, such as an advertisement for women in their thirties, an advertisement on a product worn by the leading character, and a purchase application or a site for purchasing the product may be extracted.

Thereafter, a digital broadcasting application is generated by formatting the base information obtained in the step S110 and the additional information selected in the step S130 (S150).

Preferably, the digital broadcasting application may include an independent execution code to be executed on a scene by-scene basis and a resource data.

That is, when the digital broadcasting application includes the independent execution code and the resource data, digital broadcasting application may be transmitted on the scene-by-scene basis. Therefore, the additional information may be easily provided, and, particularly, the additional information complying with the base information is provided to a specific viewer or a specific viewer group.

A method for formatting the base information and the additional information is described in more detail below.

Areas of a screen reserved for the base information and the additional information are allocated for each scene, and the base information and the additional information may be disposed in the areas for the base information and the additional information, respectively.

That is, the digital broadcasting application is generated by disposing the base information obtained in the step S110 in the area reserved for the base information, and the additional information obtained in the step S130 in the area reserved for the additional information.

For instance, the area reserved for the additional information may be disposed at a right portion of the scene, or may overlap with that of the base information.

Generally, the base information is disposed in the area for the base information, and the additional information is disposed in the area for the additional information. However, a portion of the area for the additional information may overlap with a portion of the area for the base information. Therefore, the base information may be displayed to overlap with the additional information.

For instance, the additional information may be disposed in a manner that the portion of the base information is occupied by the additional information displayed as a popup window or a banner in order to use the scene efficiently.

In addition, after personalizing the additional information according to a viewer profile, and generating a plurality of scenes corresponding to the additional information, a scene identification information corresponding to the viewer profile may be allocated to each of the plurality of scenes.

The scene identification information may be used as a means for selecting a scene in the receiver or the application providing server. A detailed description thereof is given below together with the description of the step S170.

Thereafter, the digital broadcasting application generated in the step S150 is transmitted to the receiver receiving the broadcast program (S170).

Preferably, the application providing server may receive, from the receiver, an application transmission request for a transmission of the digital broadcasting application generated to correspond to the broadcast program.

When the application providing server receives the application transmission request, the application providing server may transmit the digital broadcasting application generated on the scene-by-scene basis.

In accordance with the conventional method, it is difficult to provide the personalized additional information since the receiver received an entirety of the digital broadcasting application. However, in accordance with the method, the present invention providing the personalized the additional information is facilitated since the receiver receives the digital broadcasting application generated on the scene-by-scene basis in the step S150.

A method for providing the personalized additional information by the application providing server is described in more detail below.

A case is assumed that the plurality of scenes are generated based on the viewer profile.

The application providing server may transmit, to the receiver, an entirety of the plurality of scenes generated based on the viewer profile.

The receiver then compares the scene identification information assigned to each scene corresponding to the viewer profile with an identification information of the receiver to extract at least one of the plurality of scenes wherein the scene identification information conforms to the identification information of the receiver.

However, a drawback of transmitting the entirety of the plurality of scenes is that a time required for transmitting the plurality of scenes increases because the receiver receives the entirety of the plurality of scenes.

Therefore, it is preferable that the application providing server extracts at least one of the plurality of scenes wherein the identification information of the receiver conforms to the scene identification information, and then transmits the extracted scene.

The application providing server receives, from the receiver, the application transmission request for the transmission of the digital broadcasting application corresponding to the broadcast program, and obtains the identification information of the receiver according to the application transmission request.

When the identification information of the receiver is obtained, the application providing server compares the scene identification information with the identification information of the receiver to extract at least one of the plurality of scenes wherein the identification information of the receiver conforms to the scene identification information. The application providing server may provide the personalized additional information to the receiver by transmitting the scene extracted from the plurality of scenes according to the application transmission request.

Accordingly, the application providing server may provide the additional information as well as the base information, and transmit the digital broadcasting application on the scene-by-scene basis to provide the additional information suitable for the viewer.

FIG. 2 is a flow diagram illustrating a method for providing an additional information of a digital broadcasting application in accordance with another embodiment of the present invention.

Referring FIG. 2, a base information of the digital broadcasting application is obtained (S210).

The base information may include a description information or an additional display information of the broadcast program. For instance, the base information may include the additional information on a leading character for a TV show and a plot of each episode thereof.

Thereafter, the additional information complying with the base information is selected by analyzing the base information obtained in the step S210 (S230).

The plurality of the additional information may be stored in the additional information providing server, and at least on may be selected from the plurality of the additional information stored therein.

The plurality of the additional information may be stored in the additional information providing server according to a classification criteria.

The additional information may include an advertisement information including informations on a purchase, a promotion and an advertisement of a product related to the broadcast program, and the network identification information representing a content for participating in the purchase and the promotion of the product.

Preferably, the receiver may access the content represented by the network identification information through a return channel.

Thereafter, a keyword is selected by analyzing the base information obtained in the step S210.

The keyword may be selected based on a title of the TV show, a name of the leading character and a plot information. In addition, the keyword may be selected by analyzing an information which is statistically extractable based on the title, e.g. an information on a main class of the viewer.

Thereafter, the additional information corresponding to the keyword is extracted from the plurality of the additional information.

For instance, when the keyword such as “drama”, “women in their thirties”, “bag” and “clothes” is extracted, the additional information corresponding to the keyword, such as an advertisement for women in their thirties, an advertisement on a product worn by the leading character, and a purchase application or a site for purchasing the product may be extracted.

Thereafter, an auxiliary digital broadcasting application is generated based on the additional information selected in the step S110.

Preferably, the auxiliary digital broadcasting application may include an independent execution code to be executed on a scene-by-scene basis and a resource data.

That is, when the auxiliary digital broadcasting application includes the independent execution code and the resource data, digital broadcasting application may be transmitted on the scene-by-scene basis. Therefore, the additional information may be easily provided, and, particularly, the additional information complying with the base information is provided to specific viewer or viewer group.

After personalizing the additional information according to a viewer profile, and generating a plurality of scenes corresponding to the additional information, a scene identification information corresponding to the viewer profile may be assigned to each of the plurality of scenes.

The scene identification information may be used as a means for selecting a scene in the receiver or the application providing server. A detailed description thereof is given below together with the description of the step S270.

In addition, the auxiliary digital broadcasting application may include an attribution information displayed by the receiver. The auxiliary digital broadcasting application refers to an application assisting the digital broadcasting application. For instance, when the digital broadcasting application provided by the application providing server corresponding to the base information is a main application, the auxiliary digital broadcasting application is an application which assists the main application by providing the additional information.

Therefore, it is preferable that the digital broadcasting application includes the attribute information for the auxiliary digital broadcasting application such that each of the auxiliary digital broadcasting application and the digital broadcasting application are displayed in predetermined regions of a screen or the scene. Moreover, the predetermined regions in which the auxiliary digital broadcasting application and the digital broadcasting application are displayed may overlap with each other. The receiver may then display the auxiliary digital broadcasting application according to the attribution information.

Thereafter, the auxiliary digital broadcasting application generated in the step S250 is transmitted to the application providing server providing the digital broadcasting application or to the receiver receiving the digital broadcasting application (S270).

A method for transmitting the auxiliary digital broadcasting application is described in more detail.

The auxiliary digital broadcasting application may be transmitted by the application providing server. That is, when the auxiliary digital broadcasting application generated by the additional information providing server is transmitted to the application providing server, and the application providing server may then transmit the digital broadcasting application and the auxiliary digital broadcasting application to the receiver according to the application transmission request.

Alternately, the auxiliary digital broadcasting application may be transmitted by the additional information providing server. That is, the digital broadcasting application is transmitted by the application providing server to the receiver, and the auxiliary digital broadcasting application is transmitted by the additional information providing server to the receiver.

When the additional information providing server transmits the auxiliary digital broadcasting application to the receiver, the additional information providing server may receive, from the receiver, an application transmission request for a transmission of the auxiliary digital broadcasting application generated to correspond to the broadcast program.

When the additional information providing server receives the application transmission request, the additional information providing server may transmit the auxiliary digital broadcasting application generated on the scene-by-scene basis to the receiver.

In accordance with the conventional method, it is difficult to provide the personalized additional information since the receiver received an entirety of the digital broadcasting application. However, in accordance with the method, the present invention providing the personalized the additional information since the receiver receives the auxiliary digital broadcasting application generated on the scene-by-scene basis in the step S250.

A method for providing the personalized additional information by the additional information providing server is described in more detail below.

A case is assumed that the plurality of scenes are generated based on the viewer profile.

The additional information providing server may transmit, to the receiver, an entirety of the plurality of scenes generated based on the viewer profile.

The receiver then compares the scene identification information assigned to each scene corresponding to the viewer profile with an identification information of the receiver to extract at least one of the plurality of scenes wherein the scene identification information conforms to the identification information of the receiver.

However, a drawback of transmitting the entirety of the plurality of scenes is that a time required for transmitting the plurality of scenes increases because the receiver receives the entirety of the plurality of scenes.

Therefore, it is preferable that the additional information providing server extracts at least one of the plurality of scenes wherein the identification information of the receiver conforms to the scene identification information, and then transmits the extracted scene.

The additional information providing server receives, from the receiver, the application transmission request for the transmission of the auxiliary digital broadcasting application corresponding to the broadcast program, and obtains the identification information of the receiver according to the application transmission request.

When the identification information of the receiver is obtained, the additional information providing server compares the scene identification information with the identification information of the receiver to extract at least one of the plurality of scenes wherein the identification information of the receiver conforms to the scene identification information. The additional information providing server may provide the personalized additional information to the receiver by transmitting the scene extracted from the plurality of scenes according to the application transmission request.

Accordingly, the additional information providing server may provide the additional information as well as the base information, and transmit the auxiliary digital broadcasting application on the scene-by-scene basis to provide the additional information suitable for the viewer.

While the present invention has been particularly shown and described with reference to the preferred embodiment thereof, it will be understood by those skilled in the art that various changes in form and details may be effected therein without departing from the spirit and scope of the invention as defined by the appended claims.

What is claimed is:

1. A method for providing an additional information of a digital broadcasting in an application providing server providing a digital broadcasting application, the method comprising steps of:
(a) obtaining a base information of a broadcast program;
(b) selecting the additional information complying with the base information by analyzing the base information;
(c) generating the digital broadcasting application by formatting the base information and the additional information; and
(d) transmitting the digital broadcasting application generated to correspond to the broadcast program to a receiver for receiving the broadcast program.

2. The method in accordance with claim 1, wherein the base information includes at least one of a description information and an additional display information of the broadcast program.

3. The method in accordance with claim 1, further comprising (e) transmitting a trigger application to the receiver prior to carrying out the step (a), and
wherein the step (a) comprises:
(a-1) receiving an identification information on the broadcast program currently received by the receiver through the trigger application; and
(a-2) identifying the broadcast program through the identification information.

4. The method in accordance with claim 1, wherein the step (b) comprises:
(b-1) storing a plurality of the additional information according to a classification criteria;
(b-2) analyzing the base information to select a keyword;
(b-3) extracting the additional information corresponding to the keyword from the plurality of the additional information.

5. The method in accordance with claim 1, wherein the step (b) comprises:
(b-1) transmitting the base information to an additional information providing server storing a plurality of the additional information according to a classification criteria; and
(b-2) extracting the additional information corresponding to the base information from the additional information providing server.

6. The method in accordance with claim 1, wherein the step (c) comprises generating the digital broadcasting application including an independent execution code to be executed on a scene-by-scene basis and a resource data, and
wherein the step (d) comprises transmitting the digital broadcasting application on the scene-by-scene basis.

7. The method in accordance with claim 6, wherein the step (c) comprises:
(c-1) allocating areas for the base information and the additional information for each scene; and
(c-2) generating the digital broadcasting application by disposing the base information and the additional information in the areas for the base information and the additional information, respectively.

8. The method in accordance with claim 7, wherein the area for the base information may overlap with the area for the additional information.

9. The method in accordance with claim 6, wherein the step (c) comprises:
(c-1) generating a plurality of scenes corresponding to the additional information based on a user profile; and
(c-2) generating the digital broadcasting application by providing an identification information corresponding to the user profile to each of the plurality of scenes, and
wherein the step (d) comprises transmitting the plurality of scenes to the receiver.

10. The method in accordance with claim 1, wherein the step (d) comprises:
(d-1) receiving an application transmission request for a transmission of the digital broadcasting application generated to correspond to the broadcast program from the receiver; and
(d-2) transmitting the digital broadcasting application to the receiver according to the application transmission request.

11. The method in accordance with claim 6, wherein the step (c) comprises:
(c-1) generating a plurality of scenes corresponding to the additional information based on a user profile; and
(c-2) generating the digital broadcasting application by assigning, to each of the plurality of scenes, a scene identification information corresponding to the user profile, and
wherein the step (d) comprises:
(d-1) receiving an application transmission request for a transmission of the digital broadcasting application generated to correspond to the broadcast program from the receiver;
(d-2) obtaining an identification information of the receiver according to the application transmission request;
(d-3) comparing the identification information of the receiver with the scene identification information to extract at least one of the plurality of scenes wherein the identification information of the receiver conforms to the scene identification information; and
(d-4) transmitting the scene extracted in the step (d-3) to the receiver according to the application transmission request.

12. The method in accordance with claim 1, the additional information includes a network identification information for a content accessible through a return channel by the receiver.

13. The method in accordance with claim 1, the additional information includes an advertisement information.

14. A method for providing an additional information of a digital broadcasting application in an additional information providing server providing the additional information, the method comprising steps of:
(a) obtaining a base information of the digital broadcasting application;
(b) selecting the additional information complying with the base information by analyzing the base information;
(c) generating an auxiliary digital broadcasting application based on the additional information; and
(d) transmitting the auxiliary digital broadcasting application to one of an application providing server providing the digital broadcasting application and a receiver receiving the digital broadcasting application.

15. The method in accordance with claim 14, wherein the base information includes at least one of a description information and an additional display information of a broadcast program.

16. The method in accordance with claim 14, wherein the step (b) comprises:
(b-1) storing a plurality of the additional information according to a classification criteria;
(b-2) analyzing the base information to select a keyword; and
(b-3) extracting the additional information corresponding to the keyword from the plurality of the additional information.

17. The method in accordance with claim 14, wherein the step (c) comprises generating the auxiliary digital broadcasting application including an independent execution code to be executed on a scene-by-scene basis and a resource data, and
wherein the step (d) comprises transmitting the auxiliary digital broadcasting application on the scene-by-scene basis.

18. The method in accordance with claim 14, wherein the step (d) comprises:
(d-1) receiving an application transmission request for a transmission of the auxiliary digital broadcasting application generated to correspond to a broadcast program; and
(d-2) transmitting the auxiliary digital broadcasting application to the receiver according to the application transmission request.

19. The method in accordance with claim 17, wherein the step (c) comprises:
(c-1) generating a plurality of scenes corresponding to the additional information based on a user profile; and
(c-2) generating the auxiliary digital broadcasting application by assigning, to each of the plurality of scenes, a scene identification information corresponding to the user profile, and
wherein the step (d) comprises:
(d-1) receiving an application transmission request for a transmission of the auxiliary digital broadcasting application generated to correspond to the broadcast program from the receiver;
(d-2) obtaining an identification information of the receiver corresponding the application transmission request;
(d-3) comparing the identification information of the receiver with the scene identification information to extract at least one of the plurality of scenes wherein the identification information of the receiver conforms to the scene identification information; and
(d-4) transmitting the scene extracted in the step (d-3) to the receiver according to the application transmission request.

20. The method in accordance with 14, the auxiliary digital broadcasting application includes an attribution information displayed by the receiver.
